(19) United States
(12) Patent Application Publication
(10) Pub. No.: US 2011/0225649 A1
(43) Pub. Date: Sep. 15, 2011

(54) Protecting Computer Systems From Malicious Software

(75) Inventors: Kulvir S. Bhogal, Pflugerville, TX (US); Lisa Seacat DeLuca, San Francisco, CA (US); Robert R. Peterson, Austin, TX (US)

(73) Assignee: International Business Machines Corporation, Armonk, NY (US)

(21) Appl. No.: 12/721,818

(22) Filed: Mar. 11, 2010

(51) Int. Cl. G06F 11/00

(52) U.S. Cl. 726/22

(57) ABSTRACT

A method, computer program product, and apparatus for determining whether newly installed software is malicious software are presented. In one illustrative embodiment, software is installed on a computer system to produce newly installed software running in a secured part of the computer system. The newly installed software is only permitted to access a subset of resources in the computer system when running in the secured part. The newly installed software is run on the computer system until a selected event occurs. The newly installed software running on the computer system is monitored until the selected event occurs. The monitoring creates information used to evaluate the software for malicious behavior. The information is presented on a display to a user after the selected event has occurred, wherein the presented information comprises a recommendation of whether to provide the software access to the resources in the computer system outside the subset of resources.

### BACKGROUND OF THE INVENTION

1. Field of the Invention

The present invention relates generally to data processing systems and more specifically to running applications on computer systems. Still more particularly, the present disclosure relates to a method and apparatus for protecting a computer system from a malicious application.

2. Description of the Related Art

The Internet is commonly used to exchange information. For example, users may send email messages, instant messages, and other types of content to each other. Further, users may purchase goods, purchase services, transact business, and perform other transactions over the Internet. Further, the Internet is commonly used to download content, such as programs, music, videos, documents, and other types of content. With the widespread use of the Internet, malicious software has become a concern for computer users.

Malicious software is also referred to as malware. Malicious software is any software that is designed to run on a computer system in a manner unintended by the owner of the computer system. Running on a computer system in a manner unintended by the owner of the computer system is also referred to as malicious behavior. For example, malicious software may include a virus, a worm, a Trojan horse, spyware, adware, and other types of software. Malicious software may have a legitimate purpose but contain features or functions that are unknown to the user. These features, if known to the user, would result in the user not installing or running the software.

Malicious software has been used to obtain personal information such as, for example, credit card numbers, social security numbers, user ID's and passwords for online accounts, and other information confidential to the user. In other examples, malicious software may be used to obtain access to the computing resources of a particular computer system.

A number of different systems are present for protecting computer systems from malicious software. For example, virus scanners and other programs are used to identify software that is known to be or may be considered malicious software.

Additionally, security mechanisms also may be used for separating the running of software from other software. This type of security mechanism is often used on untested software or untrusted software. This type of security system typically controls the resources that unknown software can use. For example, a separate space on a disk drive or memory from other software may be used. This separate disk space and memory does not allow the software to access other disk space or memory used for other software running on the computer system. This type of system may virtualize resources for use by the untrusted software to avoid any undesired access or changes to the resources on the computer system.

For example, a virtual machine may be used to emulate the entire computer system. Other systems may limit resources that the software can access. These limitations may include, for example, without limitation, limits to input/output band width, disk usage, network access, files, and other resources.

### BRIEF SUMMARY OF THE INVENTION

A method, computer program product, and apparatus for determining whether newly installed software is malicious software are presented. In one illustrative embodiment, software is installed on a computer system to produce newly installed software running in a secured part of the computer system. The newly installed software is only permitted to access a subset of resources in the computer system when running in the secured part. The newly installed software is run on the computer system until a selected event occurs. The newly installed software running on the computer system is monitored until the selected event occurs. The monitoring creates information used to evaluate the software for malicious behavior. The information is presented on a display to a user after the selected event has occurred, wherein the presented information comprises a recommendation of whether to provide the software access to the resources in the computer system outside the subset of resources.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 is a block diagram of a data processing system in which illustrative embodiments may be implemented;

FIG. 3 is an illustration of a software environment depicted in accordance with an illustrative embodiment;

FIG. 4 is an illustration of a graphical user interface presenting a recommendation depicted in accordance with an illustrative embodiment;

FIG. 5 is an illustration of a graphical user interface for presenting use statistics depicted in accordance with an illustrative embodiment;

FIG. 6 is another illustration of a graphical user interface presenting a recommendation depicted in accordance with an illustrative embodiment;

FIG. 7 is another illustration of a graphical user interface for presenting use statistics depicted in accordance with an illustrative embodiment;

FIG. 8 is a flowchart of a process for running a software presented in accordance with an illustrative embodiment; and

FIG. 9 is a flowchart of a process for protecting a system from malicious software presented in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction run system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server computer. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

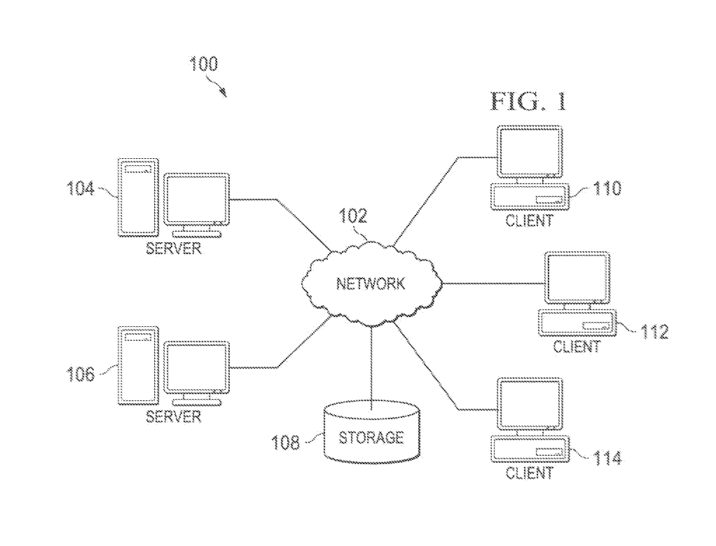

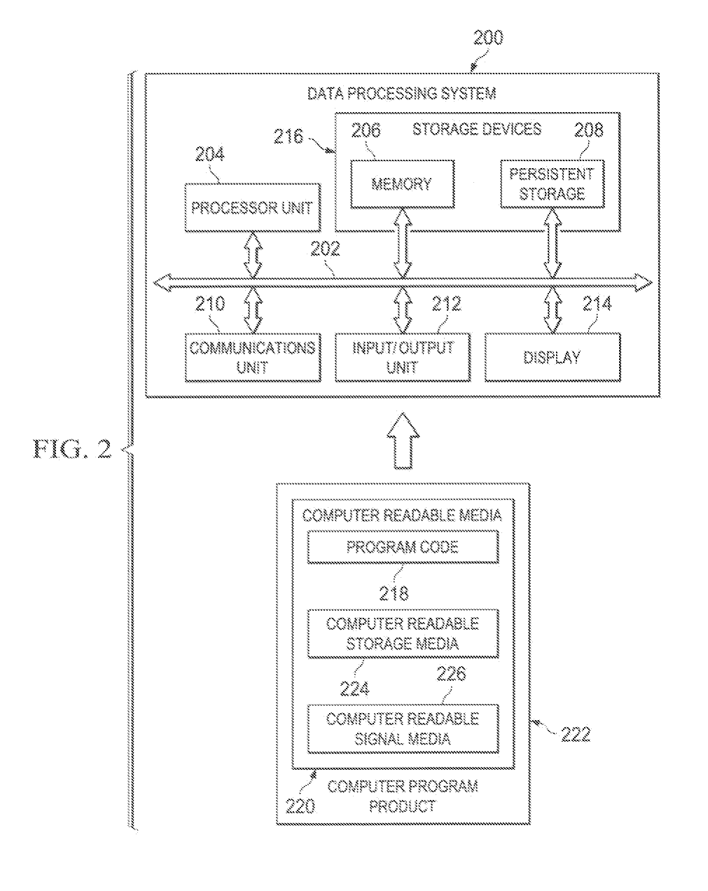

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are client computers to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In one or more illustrative embodiments, program code downloaded to a client computer, such as client computer 110, may be run in a manner to protect the client computer from malicious software. In other illustrative embodiments, program code running on one or more server computers, such as server computer 104, protects client computer 110 from malicious software.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server computer 104 or client computer 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 comprises a number of processors or may be a multi-processor core, depending on the particular implementation. A number, as used herein with reference to an item, refers to one or more items. For example, a number of processors is one or more processors. In these examples, processor unit 204 may be one or more processors. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instruction are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222 in these examples. In one example, computer readable media 220 may be computer readable storage medium 224 or computer readable signal medium 226. Computer readable storage medium 224 may include, for example, an optical or magnetic disc that is inserted or placed into a drive or other device that is part of persistent storage 208 for transfer onto a storage device, such as a hard drive that is part of persistent storage 208. Computer readable storage medium 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226, Computer readable signal media 226 may be, for example, a propagated data signal containing program code 218. For example computer readable signal media 226 may be an electro-magnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server computer to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments recognize and take into account a number of considerations. For example, the different illustrative embodiments recognize and take into account that although systems such as sandboxes can be used in conjunction with virus scanning programs, these types of systems or techniques may be more complicated and time consuming than desired by users. For example, with current isolation techniques, the user sets up the environment that is used by the software. The user then elects to run that software in the environment. This type of process is too advanced for many users to employ.

Thus, the different illustrative embodiments provide a method and apparatus for for determining whether newly installed software is malicious software are presented. In one illustrative embodiment, software is installed on a computer system to produce newly installed software running in a secured part of the computer system. The newly installed software is only permitted to access a subset of resources in the computer system when running in the secured part. The newly installed software is run on the computer system until a selected event occurs. The newly installed software running on the computer system is monitored until the selected event occurs. The monitoring creates information used to evaluate the software for malicious behavior. The information is presented on a display to a user after the selected event has occurred, wherein the presented information comprises a recommendation of whether to provide the software access to the resources in the computer system outside the subset of resources.

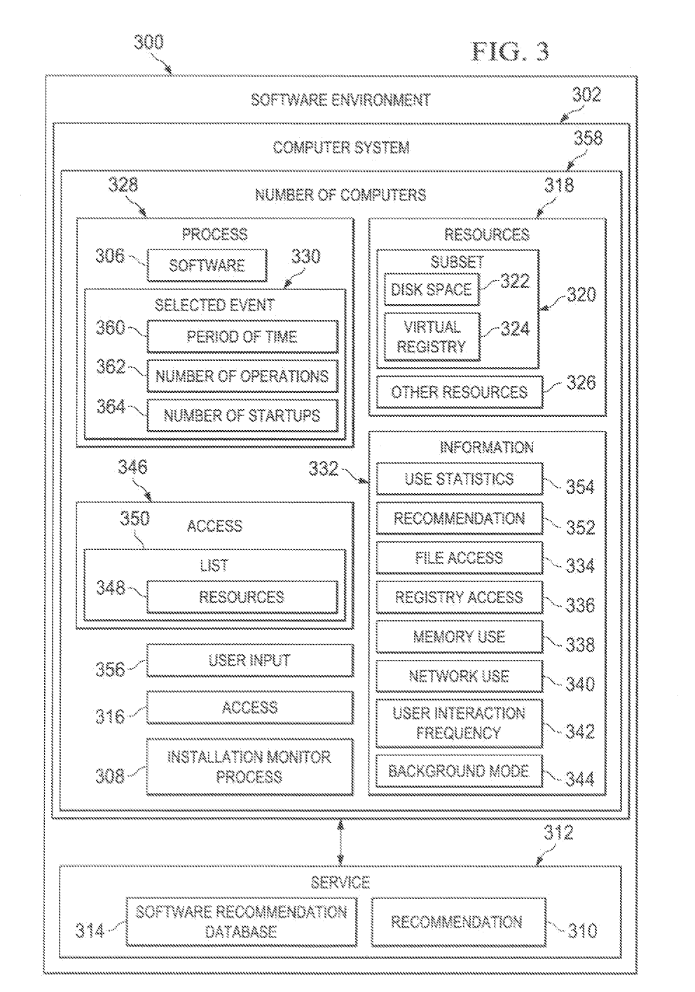

With reference now to FIG. 3, an illustration of a software environment is depicted in accordance with an illustrative embodiment. In this example, software environment 300 is an example of a software environment that may be present in network data processing system 100 in FIG. 1. In this illustrative example, software environment 300 includes computer system 302. Computer system 302 is number of computers 304. In these illustrative examples, software 306 is downloaded to be installed and run on computer system 302. As used herein, software 306 is also referred to as newly installed software. Number of computers 304 in computer system 302 may be implemented using a data processing system such as data processing system 200 in FIG. 2.

Software 306 may be a number of programs that are capable of running on a processor unit, such as processor unit 204 in FIG. 2. Software 306 may comprise an installation package. The installation package may contain program code that installs software 306 onto number of computers 304. Installing software 306 means copying files, registry entries, system settings, or any combination thereof, onto number of computers 304.

In these illustrative examples, software environment 300 may be used to run software 306 in a protected manner. In other words, software 306 may be run in a manner that avoids undesired actions with respect to other software and information that may be on computer system 302. For example, access to personal information and changes to files may be prevented within software environment 300 in the different illustrative examples.

Installation monitor process 308 monitors processes running on number of computers 304. When installation monitor process 308 detects that program code for software 306 is run on number of computers 304, Installation monitor process 308 may pause the installation program. This program code may be, for example, installation program and/or installation package for software 306. Installation monitor process 308 may request recommendation 310 from service 312 with respect to software 306. Installation monitor process 308 may identify software 306 to service 312 using an identifier. The identifier may be a file name, name and version number of the software, an MD5 hash, or any other suitable identifier.

In the illustrative examples, service 312 is a computer system that accesses software recommendation database 314 in response to receiving a request from number of computers 304. Service 312 may locate software 306 in software recommendation database 314 using the identifier received from number of computers 304. In some illustrative examples, the software recommendation database 314 contains statistics with respect to whether software 306 is known to service 312 to be malware. In one illustrative embodiment, the statistics comprise a particular number of reports that software 306 is malware. Software recommendation database 314 may be updated each time a user decides whether to install software 306 with access 316 to all of resources 318 or to delete software 306. Additional software may be added to software recommendation database 314 in the same or a similar manner.

Once recommendation 310 is received from service 312, recommendation 310 is presented to the user. In some illustrative embodiments, recommendation 310 is either a recommendation to install the software with access 316 to subset 320 of resources 318, a recommendation to install the software with access 316 to all of resources 318, or a recommendation not to install software 306. The user may then decide whether to install the software with access 316 to subset 320 of resources 318, install the software with access 316 to all of resources 318, or not to install the software 306. The decision of the user may be independent of recommendation 310. In other words, recommendation 310 may be a recommendation not to install software 306, but the user may choose to install software 306 with access 316 to all of resources 318.

In these depicted examples, the user decides to install software 306 in a secured part of computer system 302. In these illustrative examples, installing software 306 in a secured part of computer system 302 means installing software 306 with access 316 to only subset 320 of resources 318. Resources 318 are the resources available to the processor running in number of computers 304. Resources 318 includes, but is not limited to, main memory, cache memory, system registry entries, and processing time. In some illustrative embodiments, resources 318 also include peripheral devices, such as mice, keyboards, audio devices, display devices, and network devices.

Subset 320 is any portion of resources 318. For example, subset 320 may comprise 500 megabytes of disk space, 256 megabytes of main memory, and access to virtual registry 324. Virtual registry 324 is a copy of the system registry that may be isolated to software 306. In other words, software 306 may read from and write to virtual registry 324 without having an effect on the system registry or other programs running on number of computers 304. Other resources 326 comprise either another subset of resources 318 or all of resources 318. In one illustrative embodiment, subset 320 and s are implemented in a virtual machine. In other words, software 306 may be installed to a virtual machine running on number of computers 304 while remaining isolated from other processes running on number of computers 304. For example, Virtual PC 2007 by Microsoft Corp. in Redmond, Wash. may be used to create a virtual machine in which software 306 may run.

Once software 306 is installed with access 316 to subset 320 of resources 318, process 328 monitors software 306 until selected event 330 occurs. Selected event 330 may be, for example, period of time 360, a number of file accesses, number of operations 362, startups 364 for software 306, or any other suitable event. Selected event 330 may be configured by the user, configured as part of recommendation 310 by service 312, or configured as a policy on number of computers 304. A policy is a setting configured by a number of system administrators to achieve a particular level of security on number of computers 304.

Software 306 is permitted to access 316 any resources 318 within subset 320 until selected event 330 has occurred. Until selected event 330 occurs, process 328 monitors the access 316 of subset 320 of resources 318 and stores the results as information 332. Information 332 may comprise file access 336, registry access 336, memory use 338, network use 340, user interaction frequency 342, and operation in background mode 344. File access 336 read or write operations to a number of files on a number of disks accessible to number of computers 304. In some illustrative embodiments, file access 336 will be to disk space 322. In such illustrative embodiments, disk space 322 contains a duplicate of a real disk in number of computers 304 that may be modified by software 306 without affecting the original files on the real disk. The number of disks may be connected to number of computers using a bus, such as Serial ATA, or using a network, such as in the case of network attached storage (NAS).

Registry access 336 read or writes operations to the system registry, or virtual registry 324 if subset 320 contains virtual registry 324. Memory use 338 may be read and/or write operations to main memory and/or changes in cache memory caused by software 306 running on number of computers 304. Network use 340 is data sent or received using a network adapter on number of computers 304. User interaction frequency 342 is the frequency with which the user interacts with software 306. For example, user interaction frequency 342 may be the number of times the user requests information from software 306, the number of times the user runs software 306, or how often the user clicks in a window presented as part of software 306. Background mode 344 is a mode of running software 306 in which no user interface for software 306 is presented. For example, software 306 running in Background mode 344 may be running as a system service.

In some illustrative embodiments, software 306 attempts to access 346 resources 348. Resources 348 are resources 318 that are not within subset 320. For example, software 306 may be installed with permission to access 316 disk space 322 and virtual registry 324, but not network access. Yet, software 306 may attempt to access 336 the network to send and/or receive data. In such illustrative embodiments, process 328 detects the attempt to access 346 resources 348. In some illustrative embodiments, process 328 prevents access 346. However, in other illustrative embodiments, process 328 presents list 350. List 350 contains a listing of resources 348 that software 306 attempted to access that were outside subset 320. In some illustrative embodiments, the user may then choose to permit the access of resources 348 or deny the access of resources 348.

When selected event 330 occurs, process 328 pauses the running of software 306. Process 328 then presents a listing of use statistics 354. Use statistics 354 is a formatted collection of information 332. For example, use statistics 354 may be presented as a particular number of file accesses 326, a particular amount of memory used 338, and a particular amount of network use 340. Process 328 may also present recommendation 310. Recommendation 310 may be based on use statistics 354 and/or recommendation 310. In other words, process 328 uses use statistics 354 and/or recommendation 310 from service 312 to identify recommendation 310. Process 328 may identify recommendation 310 using a number of preconfigured rules and/or policies. In this illustrative embodiment, recommendation 310 is selected from a recommendation to install the software with access 316 to other resources 326, a recommendation to extend selected event 330 to collect further information 332, and a recommendation to delete software 306 from number of computers 304. Other resources 326 are the resources 318 not contained in subset 320. In another illustrative embodiment, however, other resources 326 are another subset of resources 318.

In some illustrative embodiments, recommendation 310 is requested from service 312 again to ensure that recommendation 310 is up-to-date. Recommendation 310 may be a factor in recommendation 310. In one illustrative embodiment, a weighted average of the values for information 332 and a value assigned to recommendation 310 is computed. If the weighted average is above a particular number, recommendation 310 may be to delete software 306 from number of computers 304. If the weighted average is below the particular number, recommendation 310 may be to install software 306 with access to other resources 326.

The values assigned to particular items in information 332 may be configured by the user or preconfigured by a system administrator as a policy. The values may be dependent on the setting of number of computers 304. Number of computers 304 in a home environment may have different values assigned for high usage of Background mode 344 than number of computers 304 in a server environment. Of course, this is an exemplary method of identifying recommendation 352 and other methods of identifying recommendation 352 will be obvious to those skilled in the art.

Process 328 then waits for user input 356. User input 356 may be in the form of a button clicked by a user using a mouse. User input 356 contains the decision of the user with respect to software 306. If user input 356 indicates to install software 306, process 328 initiates installation of software 306 in number of computers 304 with access to all of resources 318. In illustrative embodiments that implement a virtual machine to separate software 306 from other processes running on number of computers 304, installing software 306 with access 316 to all of resources 318 may comprise running the installation package for software 306 outside of the virtual machine.

In illustrative embodiments in which a duplicate file structure and/or registry structure is stored for use by software 306, process 328 may duplicate the changes to disk space 322 and virtual registry 324 on the real disk and in the real registry in number of computers 304. In yet other illustrative embodiments, Installation monitor process 308 records the files and registry settings added, modified, and deleted during installation of software 306 with access 316 to subset 320 of resources 318. The record may then be played back to install software 306 using the actual disk and actual registry in number of computers 304. In yet other illustrative embodiments, process 328 determines a difference or delta between disk space 322 and the actual disk in number of computers 304. Likewise, process 328 may also determine a delta between virtual registry 324 and the actual registry for number of computers 304. If user input 356 indicates that software 306 is to be installed, process 328 ceases monitoring software 306. If user input 356 indicates that selected event 330 is to be extended, process 328 continues to monitor software 306 and store information 332.

Once user input 356 is received, process 328 transmits a notification to service 312. The notification may include an identification of software 306 and the decision contained in user input 356. In these examples, user input 356 includes a decision to install software 306 with access to other resources 326. In this illustrative example, other resources 326 include access to all of resources 318. Thus, process 328 transmits a notification to service 312 that includes an identifier of software 306 and the decision that the software be installed with access to other resources 326. Service 312 may update software recommendation database 314 with the decision. In this illustrative embodiment, the notification sent by process 328 to service 312 causes service 312 to be more likely to return recommendation 310 that software 306 be installed to another computer system requesting recommendation 310 in the future. Likewise, a notification including a decision to delete software 306 will cause service 312 to be more likely to make recommendation 310 that software 306 not be installed or deleted in response to requests from other computer systems in the future.

The illustration of number of computers 304 in software environment 300 is not meant to imply physical or architectural limitations to the manner in which different features may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, process 328 may monitor additional types of information 332 for software 306. In one illustrative embodiment, process 328 monitors network addresses with which software 306 communicates. If the network addresses are known to be associated with malicious individuals or systems, recommendation 310 is more likely to delete software 306 from number of computers 304. As another example, process 328 may pause software 306 from running on number of computers 304 while list 350 is presented and the user decides whether to allow the access. Process 328 may also allow or deny the access automatically after a period of time elapses without the user inputting a decision.

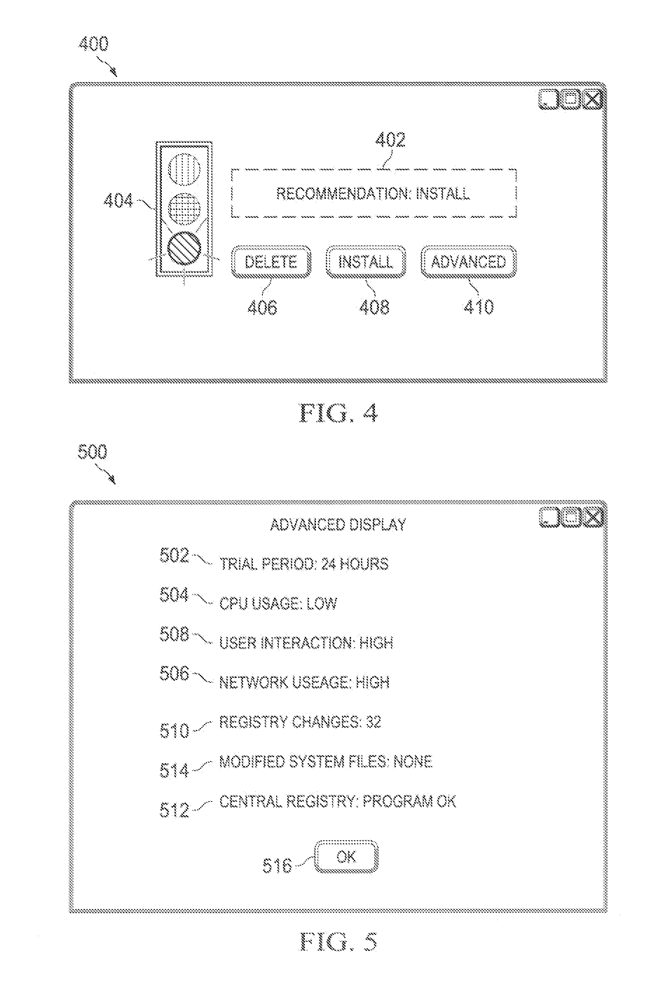

Turning now to FIG. 4, an illustration of a graphical user interface presenting a recommendation is depicted in accordance with an illustrative embodiment. Dialog 400 may be displayed using display adapter 214 from FIG. 2. A process, such as process 328 in FIG. 3, may present dialog 400 after a selected event has occurred, such as selected event 330.

Dialog 400 contains recommendation 402, graphic 404, button 406, button 408, and button 410. Recommendation 402 is an example implementation of recommendation 310. In this illustrative example, recommendation 402 is a recommendation to allow the software access to all system resources. Graphic 404 is a graphical representation of recommendation 402. In this illustrative example, graphic 404 is a green traffic light, indicating that the user should proceed with allowing the software access to all system resources. Button 406 causes a process to delete the software being monitored. In one illustrative embodiment, the uninstallation routine of the software is triggered as a result of activating button 406.

Button 408 causes a process to install the software being monitored. The installation may occur by installing the software in the computing environment outside the virtual environment, replaying a recorded installation process for the software that was recorded when the software was installed with access to a subset of resources, copying the differences between the virtual file system and virtual registry to the actual file system and virtual registry, respectively, or any other suitable installation method.

Button 410 displays additional information regarding the use of resources by the software being monitored. The information displayed as a result of activating button 410 is an example implementation of use statistics 354 in FIG. 3.

Turning now to FIG. 5, an illustration of a graphical user interface for presenting use statistics is depicted in accordance with an illustrative embodiment. Dialog 500 may be displayed using display adapter 214 from FIG. 2. A process, such as process 328 in FIG. 3, may present dialog 500 after button is pressed, such as button 410.

Text 502 indicates that the trial period for the software was 24 hours. The end of the trial period is an example of selected event 330. When 24 hours elapses after installation of the software, selected event 330 has occurred. Text 504 indicates that CPU usage by the software being monitored was low. In one illustrative embodiment, a number of thresholds are configured such that dialog 500 presents low, medium, or high CPU usage in text 504. Text 504 may also be presented as an average percentage of available CPU resources used by the software when monitoring begins until the selected event occurs.

Text 504 indicates that network usage by the software being monitored was low. In one illustrative embodiment, a number of thresholds are configured such that dialog 500 presents low, medium, or high network usage in text 506. The thresholds may be configured as particular amounts of data sent, particular amounts of data received, or particular amounts of data transmitted and received on behalf of the software being monitored. In other illustrative embodiments, text 506 is presented as a percentage of available network resources used by the software when monitoring begins until the selected event occurs.

Text 508 indicates a user interaction level. In some illustrative embodiments, the user interaction level means the frequency with which the user interacted by typing or clicking in the graphical user interface for the software. In other illustrative embodiments, the user interaction level means how frequently the software was run by the user.

Text 510 is an indication of the number of changes to the registry made by the software being monitored. In some illustrative embodiments, the number of changes were made to the virtual registry during the monitoring.

Text 512 indicates that the central registry reports that the program is OK. Text 512 may be based on recommendation 310 from service 312 in FIG. 3. The software may be designated as OK if the software is not known to be malicious by the central registry service.

Text 514 indicates which, if any, system files were modified by the software. In one illustrative embodiment, a high number of system files modified by the software being monitored is one indication that the software may be malicious. A system file is a file used by other software and/or the operating system. For example, a dynamic linked library (DLL) file used by an operating system is a system file. In this illustrative example, no system files were modified by the software being monitored. Button 516 removes dialog 500 from the graphical user interface.

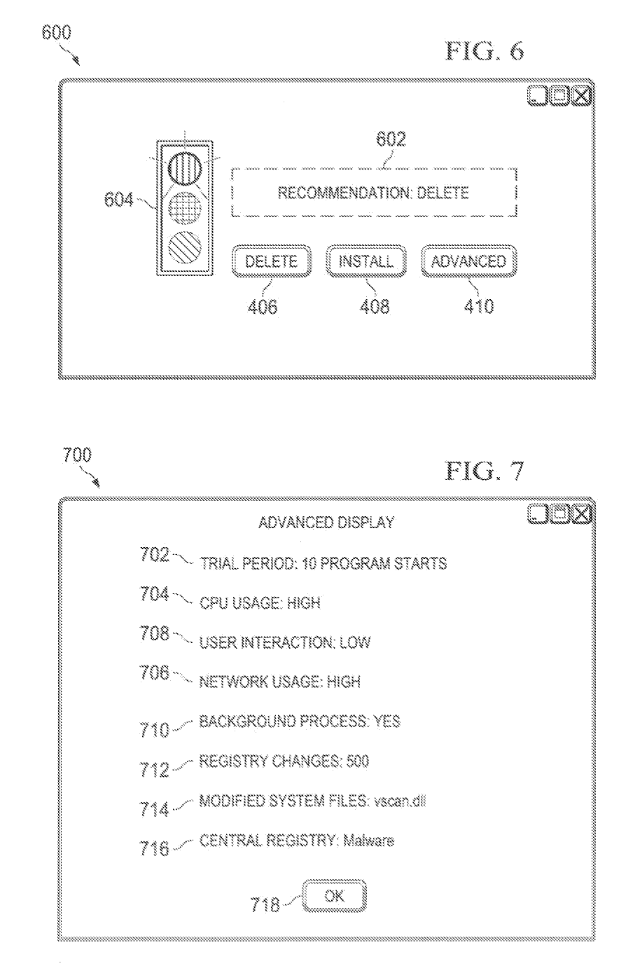

Turning now to FIG. 6, another illustration of a graphical user interface presenting a recommendation is depicted in accordance with an illustrative embodiment. Dialog 600 may be displayed using display adapter 214 from FIG. 2. A process, such as process 328 in FIG. 3, may present dialog 600 after a selected event has occurred, such as selected event 330.

Recommendation 602 in dialog 600 is another example implementation of recommendation 310 in FIG. 3. In this illustrative example, recommendation 602 is a recommendation to delete the software. Recommendation 602 may be issued if it is believed that the software is potentially malicious. Graphic 604 is a graphical representation of recommendation 602. In this illustrative example, graphic 604 is a red traffic light, indicating that the user should delete the software.

Turning now to FIG. 7, another illustration of a graphical user interface for presenting use statistics is depicted in accordance with an illustrative embodiment. Dialog 700 may be displayed using display adapter 214 from FIG. 2. A process, such as process 328 in FIG. 3, may present dialog 700 after button is pressed, such as button 410.

Text 702 indicates that the trial period for the software was 10 program starts of the software being monitored. The trial period is an example of selected event 330. Text 704 indicates that CPU usage by the software being monitored was high. In one illustrative embodiments, a number of thresholds are configured such that dialog 700 presents low, medium, or high CPU usage in text 704. Text 704 may also be presented as an average percentage of available CPU resources used by the software over the selected event.

Text 706 indicates that network usage by the software being monitored was high. In one illustrative embodiment, a number of thresholds are configured such that dialog 700 presents low, medium, or high network usage in text 718. The thresholds may be configured as particular amounts of data sent, particular amounts of data received, or particular amounts of data transmitted and received on behalf of the software being monitored. In other illustrative embodiments, text 718 is presented as a percentage of available network resources used by the software when monitoring begins until the selected event occurs.

Text 708 indicated a user interaction level. In some illustrative embodiments, the user interaction level means the frequency with which the user interacted by typing or clicking in the graphical user interface for the software. In other illustrative embodiments, the user interaction level means how frequently the software was run by the user. In this illustrative embodiment, user interaction was recorded as low.

Text 710 is an indication of whether the software was run in background mode, such as Background mode 344 in FIG. 3. The software may be identified as running in background mode if the software does not present a graphical user interface or other interface with which the user may interact. Alternatively, the software may be identified as running in a background mode if the software runs as a system service and/or when the user is not logged in. In this illustrative example, the software was recorded as running as a background process.

Text 712 is an indication of the number of changes to the registry made by the software being monitored. In some illustrative embodiments, the number of changes were made to the virtual registry during the monitoring.

Text 714 indicates which, if any, system files were modified by the software. In one illustrative embodiment, a high number of system files modified by the software being monitored is one indication that the software may be malicious. A system file is a file used by other software and/or the operating system. For example, a dynamic linked library (DLL) file used by an operating system is a system file. In this illustrative example, vscan.dll is a system file that was modified by the software being monitored.

Text 716 indicates that the central registry reports that the program is malware. Text 716 may be based on recommendation 310 from service 312 in FIG. 3. The program may be designated as malware if the program is known to be malicious by the central registry service. Button 718 removes dialog 500 from the graphical user interface.

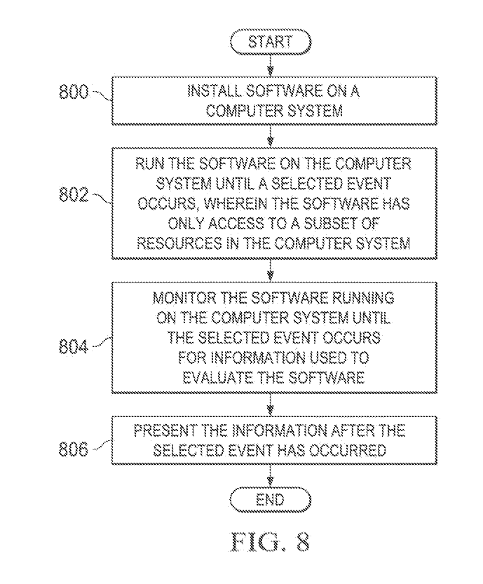

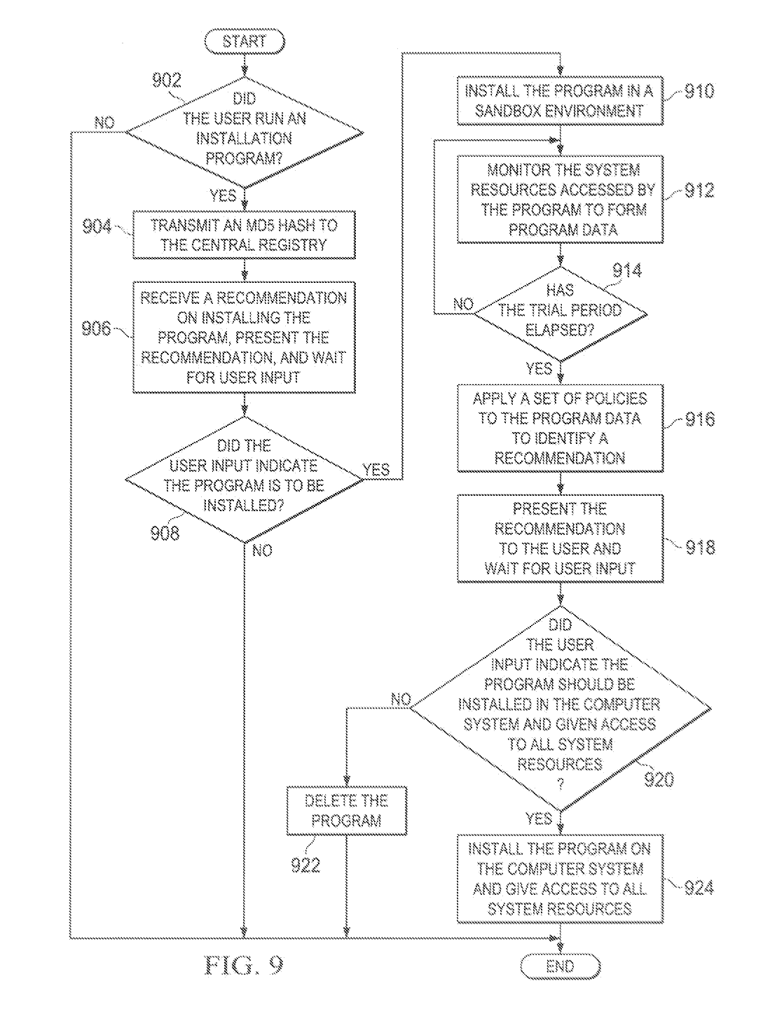

Turning now to FIG. 8, a flowchart of a process for running a software is presented in accordance with an illustrative embodiment. The process may be performed in a software environment, such as software environment 300. The process may be performed by a number of computers, such as number of computers 304.

The process begins by installing software on a computer system (step 800). The process then runs the software until a selected event occurs, wherein the software has only access to a subset of resources in the computer system (step 802). The selected event may be the expiration of a period of time, a number of startups of the software, a number of file system accesses, or another suitable period. The resources may be any system resources, including, without limitation, disks, main memory, cache, CPU, and peripherals such as network devices, audio devices, and input/output ports.

The process then monitors the software running on the computer system until the selected event occurs for information used to evaluate the software (step 804). The information may comprise file access, registry access, memory access, network access, user interaction frequency, operation in background mode, or any other suitable information. The process then presents the information after the selected event occurs (step 806). The process terminates thereafter.

Turning now to FIG. 9, a flowchart of a process for protecting a system from malicious software is presented in accordance with an illustrative embodiment. The process may be performed in a software environment, such as software environment 300. The process may be performed by a number of computers, such as number of computers 304.

The process begins by determining whether the user initiated an installation program (step 902). An installation program is a program that copies files and settings onto a system for the purpose of running the program being installed by the installation program. If the process determines that the user did not initiate an installation program, the process terminates. If the process determines that the user did initiate an installation program, the process transmits an MD5 hash to the central registry (step 904). The MD5 hash identifies the program to the central registry. The central registry may locate a recommendation in a software recommendation database by using the MD5 hash. The central registry is an example implementation of service 312 in FIG. 3.

The process then receives a recommendation on installing the program, presents the recommendation, and waits for user input (step 906). The process then determines whether the user input indicates the program is to be installed (step 908). If the process determines that the user input indicates the program is not to be installed, the process terminates. If the process determines that the user input indicates the program is to be installed, the process installs the program in a sandbox environment (step 910). A sandbox environment is a separate copy of the file system and system registry that is accessible only by the software being installed. Thus, any changes the software attempts to make to the file system or system registry are made only to the duplicates. Alternatively, the process may install the program in a virtual machine.

The process then monitors the system resources accessed by the program to form program data (step 912). The process then determines whether the trial period has elapsed (step 914). The expiration of the trial period is an example implementation of selected event 330 in FIG. 3. If the process determines that the trial period has not elapsed, the process repeats step 912. If the process determines that the trial period has elapsed, the process applies a set of policies to the program data to identify a recommendation (step 916). The policies may provide values for the various program data categories to calculate a weighted average. The policies may also include ranges for the weighted average. The ranges may correspond to a particular recommendation. For example, a weighted average between 1 and 2 may receive a recommendation to extend the trial period. The policies may be configured by the user or downloaded from a network, such as a corporate network.

The process then presents the recommendation to the user and waits for user input (step 918). The process then determines if the user input indicates that the program should be installed in the computer system and given access to all system resources (step 920). The user may activate a button, such as button 408 in FIG. 4 to cause the software to be given access to all system resources. If the process determines that the user input does not indicate the program should be installed in the computer system and given access to all system resources, the process deletes the program (step 922) and terminates thereafter.

If the process determines that the user input indicates the program should be installed in the computer system and given access to all system resources at step 920, the program installs the software in the computer system and gives access to all system resources (step 924). The process terminates thereafter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For example, the process may not receive a recommendation on installing the program at step 906 if the central registry is inaccessible. In such an illustrative embodiment, the process may not perform step 906. In another example, the process may download and update a set of policies to apply to the program data prior to performing step 916. The download may be received from a centralized server. Additionally, the process may present additional statistics on the use of system resources by the software at step 918. The use statistics may be an example implementation of use statistics 354 in FIG. 3.

Thus, the different illustrative embodiments protect a computer system from malicious software by providing an isolated environment in which to run the software for a period of time. It is common that malware will begin to act maliciously as soon as it is installed on a system. Thus, the different illustrative embodiments recognize that monitoring of resources after installation is effective in aiding the user in determining whether software is malware. The different illustrative embodiments also recognize and take into account that the user may want the software to have access to all system resources after it is determined that the software is not malware.

Thus, the different illustrative embodiments provide a method, computer program product, and apparatus for determining whether newly installed software is malicious software are presented. In one illustrative embodiment, software is installed on a computer system to produce newly installed software running in a secured part of the computer system. The newly installed software is only permitted to access a subset of resources in the computer system when running in the secured part. The newly installed software is run on the computer system until a selected event occurs. The newly installed software running on the computer system is monitored until the selected event occurs. The monitoring creates information used to evaluate the software for malicious behavior. The information is presented on a display to a user after the selected event has occurred, wherein the presented information comprises a recommendation of whether to provide the software access to the resources in the computer system outside the subset of resources.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction running system. For the purposes of this description, a computer-usable or computer readable medium can be any tangible apparatus that can contain, store, communicate, propagate, or transport the program for use by or in connection with the instruction running system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual running of the program code, bulk storage, and cache memories which provide temporary storage of at least some program code in order to reduce the number of times code must be retrieved from bulk storage during running.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining whether newly installed software is malicious software, the method comprising:
installing software on a computer system to produce newly installed software running in a secured part of the computer system, wherein the newly installed software is only permitted to access a subset of resources in the computer system when running in the secured part;
running the newly installed software on the computer system until a selected event occurs;
monitoring the newly installed software running on the computer system until the selected event occurs, wherein the monitoring creates information used to evaluate the software for malicious behavior; and
presenting the information on a display to a user after the selected event has occurred, wherein the presented information comprises a recommendation of whether to provide the software access to the resources in the computer system outside the subset of resources.

2. The method of claim 1 further comprising:
responsive to receiving a user input, providing the newly installed software access to other resources in the computer system in addition to the subset of resources.

3. The method of claim 1 further comprising:
transmitting an identifier for the newly installed software to a service; and
receiving, from the service, the recommendation on whether to provide the software access to the resources in the computer system outside the subset of resources.

4. The method of claim 1, wherein the step of presenting the information after the selected event has occurred comprises:
presenting use statistics for the subset of resources by the newly installed software after the selected event occurs.

5. The method of claim 1, wherein the information comprises at least one of a file access by the newly installed software, a registry access by the newly installed software, processor unit use by the newly installed software, memory use by the newly installed software, network use by the newly installed software, how frequently the newly installed software has been started by a user, a user interaction frequency with the newly installed software, whether the newly installed software is started during an operating system startup phase, and how often the newly installed software runs in a background mode.

6. The method of claim 1, wherein the subset of resources comprises virtualized disk space and a virtualized registry.

7. The method of claim 1, wherein the resources are first resources, and further comprising:
responsive to the newly installed software requesting access to second resources that are not in the subset of the resources, presenting a list of the second resources and waiting for a user input;
responsive to the user input indicating that the access is permitted, allowing the access to the second resources.

8. The method of claim 1, wherein the selected event is selected from one of an expiration of a period of time, a number of operations, and a number of startups of the newly installed software.

9. A computer program product comprising:
a computer readable storage medium;
program code, stored on the computer readable storage medium, for installing software on a computer system to produce newly installed software running in a secured part of the computer system, wherein the newly installed software is only permitted to access a subset of resources in the computer system when running in the secured part;
program code, stored on the computer readable storage medium, for running the newly installed software on the computer system until a selected event occurs;
program code, stored on the computer readable storage medium, for monitoring the newly installed software running on the computer system until the selected event occurs for information used to evaluate the software, wherein the monitoring creates information used to evaluate the software for malicious behavior; and
program code, stored on the computer readable storage medium, for presenting the information on a display to a user after the selected event has occurred, wherein the presented information comprises a recommendation of whether to provide the software access to the resources in the computer system outside the subset of resources.

10. The computer program product of claim 9 further comprising:
program code, stored on the computer readable storage medium, for, responsive to receiving a user input, providing the newly installed software access to other resources in the computer system in addition to the subset of resources.

11. The computer program product of claim 9 further comprising:
transmitting an identifier for the newly installed software to a service; and
receiving, from the service, the recommendation on whether to provide the software access to the resources in the computer system outside the subset of resources.

12. The computer program product of claim 9, wherein the program code for presenting the information after the selected event has occurred comprises:
program code, stored on the computer readable storage medium, for presenting use statistics for the subset of resources by the newly installed software after the selected event occurs.

13. The computer program product of claim 9, wherein the information comprises at least one of a file access by the newly installed software, a registry access by the newly installed software, processor unit use by the newly installed software, memory use by the newly installed software, network use by the newly installed software, how frequently the newly installed software has been started by a user, a user interaction frequency with the newly installed software, whether the newly installed software is started during an operating system startup phase, and how often the newly installed software runs in a background mode.

14. The computer program product of claim 9, wherein the subset of resources comprises virtualized disk space and a virtualized registry.

15. The computer program product of claim 9, wherein the resources are first resources, and further comprising:
program code, stored on the computer readable storage medium, for, responsive to the newly installed software requesting access to second resources that are not in the subset of the resources, presenting a list of the second resources and waiting for a user input;
program code, stored on the computer readable storage medium, for, responsive to the user input indicating that the access is permitted, allowing the access to the second resources.

16. The computer program product of claim 9, wherein the selected event is selected from one of an expiration of a period of time, a number of operations, and a number of startups of the newly installed software.

17. An apparatus comprising:
a bus;
a memory connected to the bus; and
a processor unit connected to the bus, wherein the processor unit is configured to install software on a computer system to produce newly installed software running in a secured part of the computer system, wherein the newly installed software is only permitted to access a subset of resources in the computer system when running in the secured part; run the newly installed software on the computer system until a selected event occurs; monitor the newly installed software running on the computer system until the selected event occurs, wherein the monitoring creates information used to evaluate the software for malicious behavior; and present the information on a display to a user after the selected event has occurred, wherein the presented information comprises a recommendation of whether to provide the software access to the resources in the computer system outside the subset of resources.

18. The apparatus of claim 17, wherein the processor unit is further configured to provide the newly installed software access to other resources in the computer system in addition to the subset of resources responsive to receiving a user input.

19. The apparatus of claim 17, wherein the processor unit is further configured to transmit an identifier for the newly installed software to a service; and receive, from the service, the recommendation on whether to provide the software access to the resources in the computer system outside the subset of resources.

20. The apparatus of claim 17, wherein the processor unit being configured to present the information after the selected event has occurred further comprises the processor unit being configured to present use statistics for the subset of resources by the newly installed software after the selected event occurs.
